(19) United States
(12) Patent Application Publication
(10) Pub. No.: US 2006/0243800 A1
(43) Pub. Date: Nov. 2, 2006

(54) Combo card reader

(76) Inventor: Chun-Sheng Wang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/242,834

(22) Filed: Oct. 5, 2005

(30) Foreign Application Priority Data
Apr. 27, 2005 (TW) 094206598

(51) Int. Cl. G06K 7/06

(52) U.S. Cl. 235/441

(57) ABSTRACT

The present invention is to provide a combo card reader, which includes a first inserting section and a second inserting section provided for receiving different types of storage units, a first reading unit and a second reading unit respectively and electrically connected with the first inserting section and the second inserting section through a switching unit, such that the reading units can transmit signals with the storage units in the corresponding inserting sections through driving the switching unit, enabling the first reading unit to read a corresponding storage unit in the first inserting section and the second reading unit to read a corresponding storage unit in the second inserting section and carrying out signal transmissions between the card reader and different kinds of storage units.

### FIELD OF THE INVENTION

The present invention relates to a combo card reader, and more particularly to a card reader having a switching unit enabling a first reading unit and a second reading unit of the card reader to read different kinds of memory cards.

### BACKGROUND OF THE INVENTION

People have increasing demands for the convenience of transmitting information in the present information era, and thus various different electronic devices are developed constantly. Particularly, portable electronic devices are extensively used in different industries. Besides changing our lifestyle, the portable devices also become an indispensable part of our life. To make an electronic device to have more functions such as a Global Positioning System (GPS), a Motion Picture Coding Expert Group Audio Layer-3 (MP3) or a camera, a high-capacity memory is required to store data. In general, extended memory cards are adopted and installed onto the electronic device.

However, the specifications and methods of reading data from a memory card used in different electronic devices vary, and thus many memory cards with various different specifications are sold in the market, and different card readers are used to read the data from these different types of memory cards. In view of this shortcoming, some manufacturers developed a prior art card reader such as a “7-in-1 PCMCIA card reader” disclosed in the R.O.C. Pat. Application No. 092214523. The card reader comprises a cartridge, a first connector with the PCMCIA interface format disposed at the front end of the cartridge, a second connector and a third connector disposed at the rear end of the cartridge; wherein the second connector has a memory card slot in compliance with the CF, MD, MMC, MS, and SD formats, and the third connector has a memory card slot in compliance with the SM, and XD formats, so that the card reader can read seven kinds of memory cards.

Besides the abovementioned electronic device, another integrated circuit card (IC card) is also very popular, which substantially affects our life. The appearance of the IC card is a plastic card similar to a general credit card or ATM card, and the IC card comes with an embedded IC chip, and its password device makes the security better than the traditional cards with magnetic tapes. Therefore, the IC card is extensively used in different industries as well as for the door security of a building, the point accumulation for consuming goods in a store, and information storage for health insurance.

Therefore, some manufacturers developed a card reader as disclosed in R.O.C. Pat. Application No. 092103740 entitled “Hybrid card reader for reading cards”, and the card reader comprises a main body for receiving a magnetic tape card, an IC card or a hybrid card, and the main body includes a magnetic tape reader and an IC card contact point module, so that the card reader can read the magnetic tape card, IC card, or hybrid card.

As there are many memory cards and IC cards in these days, the foregoing two prior art card readers can avoid purchasing many kinds of card readers, but any of these two kinds of card readers cannot read both memory cards and IC cards. If a consumer holds a memory card and an IC card, simultaneously then at least two card readers are needed for reading the cards. Such arrangement not incurs more costs to the users, but also has inconvenience and trouble of using different kinds of card readers. Therefore, it is good news to have an expanded card reader that can fit both formats of the memory cards.

### SUMMARY OF THE INVENTION

In view of the foregoing shortcomings of the prior art, the inventor of the present invention based on years of experience to conduct extensive researches and experiments to improve the prior art, and finally invented a combo card reader in accordance with the present invention.

Therefore, it is a primary objective of the present invention to provide a combo card reader comprising a first inserting section, a second inserting section, a first reading unit, a second reading unit, and a switching unit; wherein the first inserting section and the second inserting section are provided for receiving different types of storage units, the first reading unit and the second reading unit are respectively and electrically connected with the first inserting section and the second inserting section through a switching unit, such that the first and second reading units can transmit signals with the storage units in the corresponding first and second inserting sections through driving the switching unit, enabling the first reading unit to read a corresponding storage unit in the first inserting section and the second reading unit to read a corresponding storage unit in the second inserting section and then carrying out signal transmissions between the card reader and different kinds of storage units.

The above and other objects, features and advantages of the present invention will become apparent from the following detailed description taken with the accompanying drawings.

### BRIEF DESCRIPTION OF THE DRAWINGS

FIG. 1 is a schematic view of a combo card reader of the present invention.

### DETAILED DESCRIPTION OF THE PREFERRED EMBODIMENTS

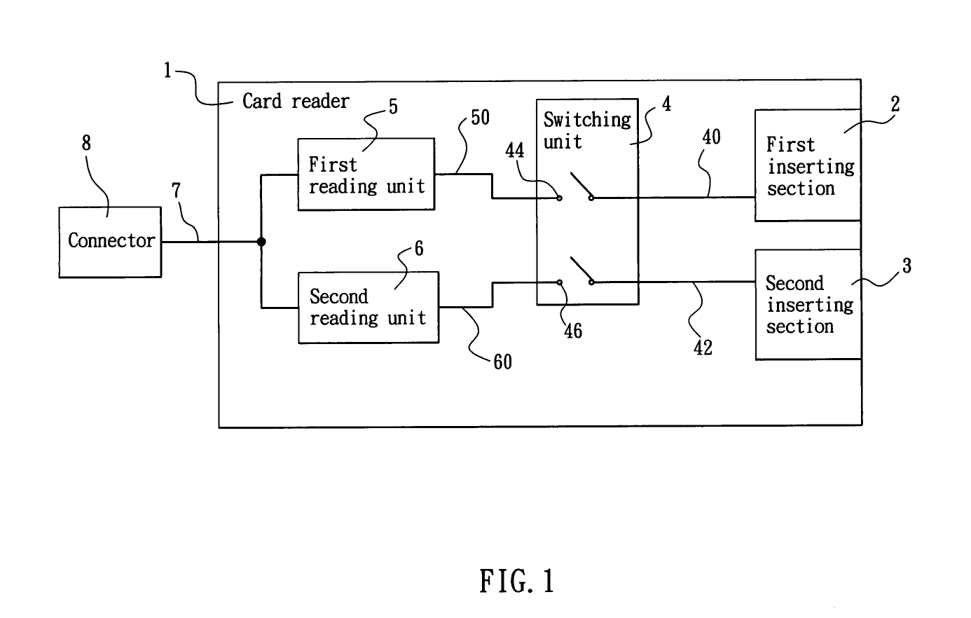

Referring to FIG. 1 for the combo card reader of the present invention, the card reader 1 comprises a first inserting section 2 and a second inserting section 3, and the inserting sections 2, 3 are provided for inserting different kinds of storage units and coupled with a switching unit 4, and the switching unit 4 is coupled separately with a first reading unit 5 and a second reading unit 6, and the reading units 5, 6 carry out signal transmissions with a storage unit in the inserting sections 2, 3 respectively. If the switching unit 4 electrically connects the first reading unit 5 with the first inserting section, then a signal transmission will be carried out between the first reading unit 5 and the storage unit in the first inserting section 2. If the switching unit 4 electrically connects the second reading unit 6 with the second inserting section 3, then a signal transmission will be carried out between the second reading unit 6 and the storage unit in the second inserting section 3. Therefore, signal transmissions can be carried out between the reading units 5, 6 and their corresponding storage unit, and the switching unit 4 electrically connects the reading units 5, 6, so that the card reader 1 can read data from different types of storage units.

Referring to FIG. 1 again for a preferred embodiment of the present invention, the first inserting section 2 comprises a plurality of different types of first slots, and these slots fits various different formats of storage units including CF cards, MD cards, MMC cards, MS cards, SD cards, XD cards, SMC cards, and MS cards, etc. The second inserting section 3 comprises a second slot therein capable of fitting various different formats of storage units including IC cards, I2C cards, SLE4418 cards, SLE4428 cards, SLE4432 cards, SLE4442 cards, and AT45D041 cards.

Referring to FIG. 1 again for the preferred embodiment, the switching unit 4 comprises a first signal transmission terminal 40, a second signal transmission terminal 42, a first contact point 44 and a second contact point 46; wherein the first signal transmission terminal 40 is coupled with the first inserting section 2, and the second signal transmission terminal 42 is coupled with the second inserting section 3, and the first contact point 44 is coupled with the first reading unit 5, and the second contact point 46 is coupled with the second reading unit 6, such that if the switching unit 4 is switched to electrically connect the first contact point 44 with the first signal transmission terminal 40, then a signal transmission will be carried out between the first reading unit 5 and the storage unit in the first inserting section 2. If the switching unit 4 is switched to electrically connect the second contact point 46 with the second signal transmission terminal 42, then a signal transmission will be carried out between the second reading unit 6 and the storage unit in the second inserting section 3.

Referring to FIG. 1 again for the preferred embodiment, the first reading unit 5 is a microprocessor of a memory card reader, and the first reading unit 5 includes a first signal transmission terminal 50 coupled with the first contact point, so that the first reading unit 5 can carry out signal transmissions with the corresponding storage units including the memory card with the formats of CF cards, MD cards, MMC cards, MS cards, SD cards, XD cards, SMC cards, and MS cards by the switching unit 4 and the first inserting section 2.

Referring to FIG. 1 again for the preferred embodiment, the second reading unit 6 is a microprocessor of an IC card reader, and the second reading unit 6 comprises a second signal transmission terminal 60 coupled with the second contact point 46, such that the second reading unit 6 can carry out signal transmissions with the corresponding storage units including IC cards, I2C cards, SLE4418 cards, SLE4428 cards, SLE4432 cards, SLE4442 cards, AT88SC1608 cards, and AT45D041 cards by the switching unit 4 and the second inserting section 3.

Referring to FIG. 1 again for the preferred embodiment, the card reader 1 further comprises a transmission line 7 and a connector 8, wherein one end of the transmission line 7 is coupled with the reading units 5, 6, and the other end coupled with the connector 8, and the connector 8 can be connected to an electronic device, so that signal transmissions can be carried out between the electronic device and the card reader 1.

While the invention herein disclosed has been described by means of specific embodiments, numerous modifications and variations could be made thereto by those skilled in the art without departing from the scope and spirit of the invention set forth in the claims.

What is claimed is:

1. A combo card reader, comprising:
a first inserting section, for inserting different kinds of storage units;
a second inserting section, for inserting different kinds of storage units;
a first reading unit, capable of carrying out a signal transmission with said storage unit in said first inserting section;
a second reading unit, capable of carrying out a signal transmission with said storage unit in said first inserting section; and
a switching unit, separately coupled with said first inserting section and said first reading unit, and said switching unit is separately and electrically coupled with said first reading unit and said first inserting section, and if said first reading unit is electrically coupled with said first inserting section, then said first reading unit is capable of carrying out a signal transmission with said storage unit in said first inserting section, and if said second reading unit is electrically coupled with said second inserting section, then said second reading unit is capable of carrying out a signal transmission with said storage unit in said second inserting section.

2. The combo card reader of claim 1, wherein said first inserting section comprises a plurality of slots therein, and said slots are different slots that fit various formats of said storage units.

3. The combo card reader of claim 1, wherein said second inserting section comprises a plurality of slots therein, and said slots are different slots that fit various formats of said storage units.

4. The combo card reader of claim 1, wherein said switching unit further comprises:
a first contact point, coupled with said first reading unit;
a second contact point, coupled with said second reading unit;
a first transmission terminal, coupled with said first inserting section, and if said first contact point is electrically coupled with said first transmission terminal, then a signal transmission can be carried out between said first reading unit and said storage unit; and
a second transmission terminal, coupled with said second inserting section, and if said second contact point is electrically coupled with said second transmission terminal, then a signal transmission can be carried out between said second reading unit and said storage unit.

5. The combo card reader of claim 1, wherein said first reading unit includes a first signal transmission terminal coupled with said switching unit.

6. The combo card reader of claim 1, wherein said second reading unit includes a second signal transmission terminal coupled with said switching unit.

7. The combo card reader of claim 1, further comprising:
a transmission line, having an end coupled with said first reading unit; and
a connector, coupled with another end of said transmission line and inserted to connect an electronic device.
